(19) United States
(12) Patent Application Publication
(10) Pub. No.: US 2007/0051537 A1
(43) Pub. Date: Mar. 8, 2007

(54) Garage door drive

(76) Inventor: Michael Hoermann, Halle/Westf (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/511,860

(22) Filed: Aug. 28, 2006

(30) Foreign Application Priority Data
Aug. 30, 2005 (DE) 20 2005 013 682.4

(51) Int. Cl. H01R 13/502

(52) U.S. Cl. 174/559

(57) ABSTRACT

The present disclosure relates to a garage door drive comprising a covering hood covering the drive unit, with at least one recess being cut-out in the covering hood which can be covered via a panel which can be placed onto the covering hood.

### CROSS-REFERENCE TO RELATED APPLICATION

This application claims priority to German Utility Model Application Serial No. 20 2005 013 682.4 filed Aug. 30, 2005, which is hereby incorporated by reference in its entirety for all purposes.

### FIELD

The present disclosure relates to a garage door drive comprising a covering hood covering the drive unit.

### BACKGROUND AND SUMMARY

Garage doors to be opened automatically typically include a door leaf which can be moved between an open position and a closed position with the help of a running rail mechanism. A carriage runs in the running rail and is connected to the door via a corresponding linkage. The carriage is moved via the garage door drive to open and close the garage door.

Garage door drives typically include a base plate receiving the drive unit and a covering hood covering this drive unit. Since the garage door drives are attached freely visible to the garage ceiling as a rule, there is a need to design these in an appealing manner. Due to the warehousing of different parts being kept as minimal as possible in the manufacture of corresponding garage door drives, the manufacturers tend to strongly restrict the variety of the different covering hoods for garage door drives. On the other hand, there is frequently the desire on the part of consumers for an individualized shape of the garage door drive in accordance with their specific design ideas.

It is therefore the object of the present disclosure to provide a generic garage door drive which can be matched in a simple and cost-effective manner with respect to its shape to the specific customer wishes of the consumers.

This object is satisfied in accordance with the present disclosure in that a garage door drive comprising a covering hood covering the drive unit is made such that at least one recess is cut-out in the covering hood which can be covered via a panel which can be placed onto the covering hood. In accordance with the solution put forward here, the actual covering hood part is therefore generally made the same. However, by the provision of an optionally large-area recess, room is created to put on a panel substantially characterizing the design of the drive unit in each case. Panels of this kind can be warehoused in a wide range of varieties and can be matched with respect to their color and/or shape to the different specific customer wishes.

In accordance with a preferred aspect of the present disclosure, figurative symbols and/or alphanumeric signs can be arranged in the recess of the covering hood. These signs can, for example, include manufacturer's data and the type designation of the garage door drive.

The panel is advantageously made as a design panel, that is as a panel with a corresponding design.

An operating field with operating buttons can be arranged in the recess of the covering hood. Here, an opening is provided at a corresponding point on the panel so that the corresponding operating field is accessible from outside through the panel.

In accordance with an advantageous aspect of the present disclosure, the covering hood and/or the panel is/are made of plastic. The panel can advantageously be releasably connected to the covering hood.

### BRIEF DESCRIPTION OF THE FIGURES

Further features, details and advantages of the present disclosure result from an embodiment shown in the drawing. There are shown:

FIG. 1 is a three-dimensional representation of a garage door drive in accordance with an embodiment of the present disclosure;

FIG. 2 shows the garage door drive in accordance with FIG. 1 with a removed panel; and

FIG. 3 shows the drive in accordance with FIG. 1 with a removed panel, but with the panel being shown in the raised state.

### DETAILED DESCRIPTION

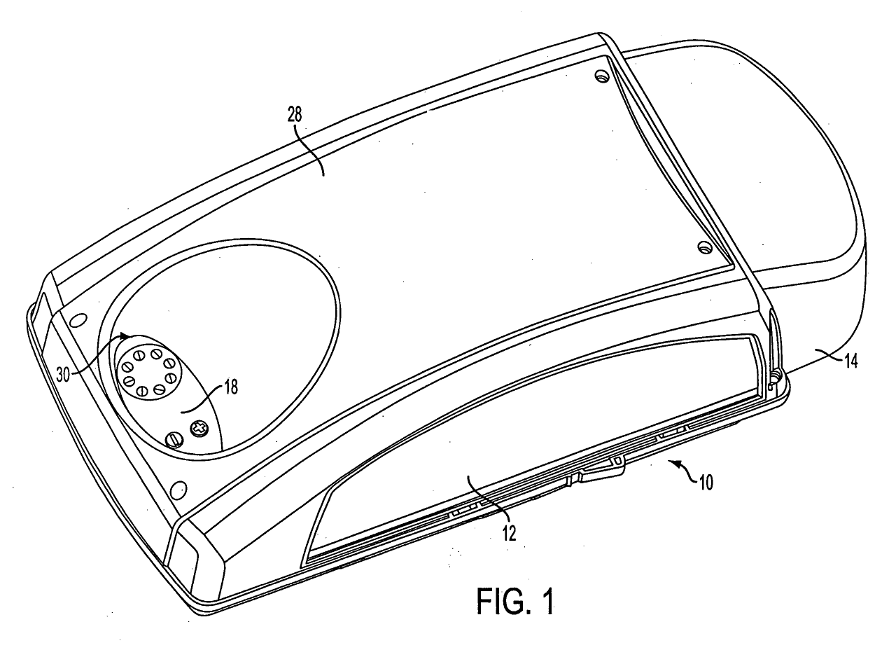

A garage door drive 10 is shown in FIG. 1 which has a covering hood 12 which fully covers a drive unit not shown in any more detail here. The part 14 of the covering hood can consist of at least partially transparent or translucent material so that a garage lighting can be integrated here.

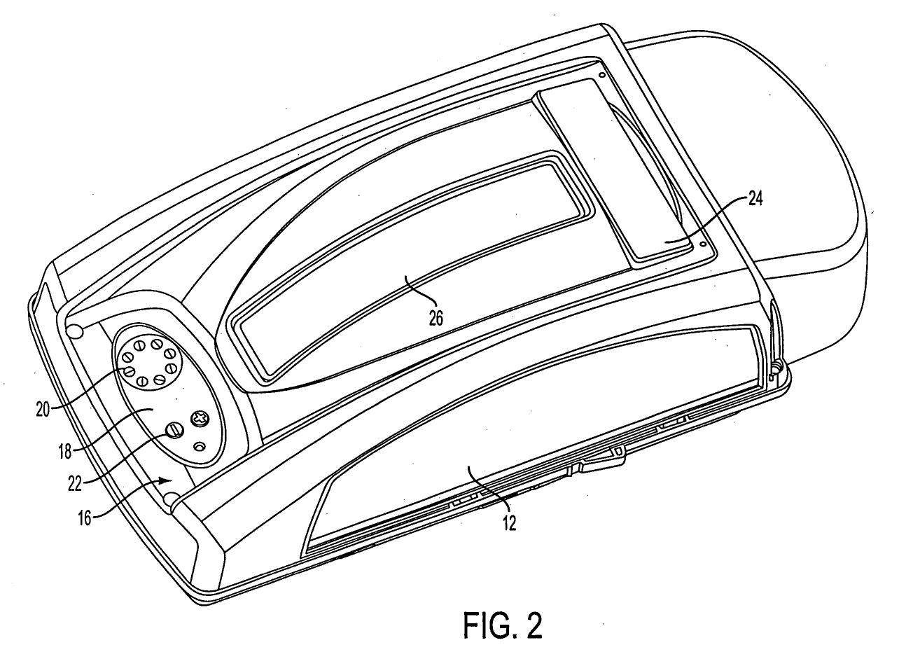

As in particular results from FIG. 2, the body of the covering hood 12 shaped substantially integrally from plastic is provided with a large-area recess 16. On the one hand, an operating field 18 is arranged in the recess 16 and operating elements 20 and 22 for the setting or programming of the garage door drive are contained in it. Furthermore, a plurality of fields 24 and 26 with alphanumeric symbols or figurative symbols are arranged in the recess 16. In the embodiment shown here, the manufacturer's name and the figurative symbol of the manufacturer are shown in the field 26, whereas the type designation of the garage door drive is reproduced in the field 24.

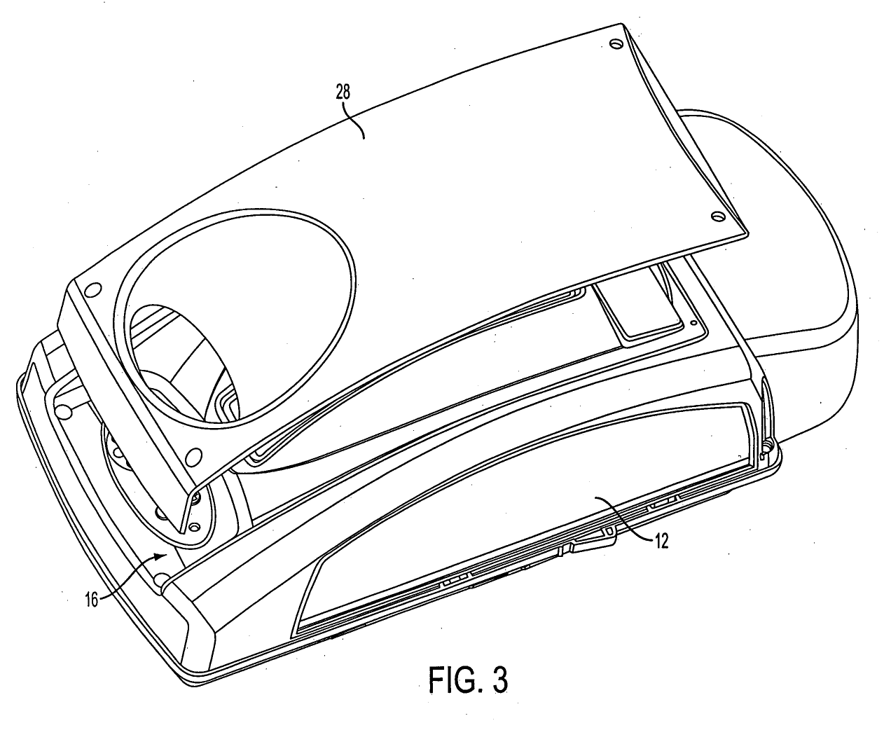

It becomes clear with reference to FIG. 3 that the corresponding recess 16 in the covering hood 12 can be covered via a panel 28. The panel 28 can be releasably connected to the covering hood 12. In FIG. 1, the panel 28 is shown in a position placed on the covering hood. The panel 28 has an opening 30 at the point at which the operating field 18 is provided in the recess 16 of the covering hood 12 (cf. FIG. 1).

In the embodiment shown here, the panel 28 is substantially matched to the other shape of the covering hood. In modified embodiments, which are not shown here, the surface of the covering hood can, however, also be made differently. Ornamental ribs, relief-like images or any other shapes can thus be provided. The corresponding panel 28 can be made as a design panel, but also in a special color scheme so that it can be matched to specific customer wishes. The customer can thus choose an individual garage door drive for his garage without it being necessary to replace whole housing parts such as complete covering hoods.

1. A garage door drive, comprising:
a drive unit; and
a covering hood covering the drive unit, the covering hood having at least one recess received therein, where said at least one recess is configured to be covered via a panel placed onto the covering hood.

2. The garage door drive in accordance with claim 1 further comprising figurative symbols and/or alphanumerical signs arranged in the recess of the covering hood.

3. The garage door drive in accordance with claim 1, wherein the panel is made as a design panel.

4. The garage door drive in accordance with claim 1, wherein an operating field with operating buttons is arranged in the recess of the covering hood; and an opening is provided at a corresponding point in the panel.

5. The garage door drive in accordance with claim 1, wherein the covering hood and/or the panel comprise plastic.

6. The garage door drive in accordance with claim 1, wherein the panel is configured to be releasably connected to the covering hood.

7. A garage door drive system, comprising:
a drive unit;
a covering hood covering the drive unit, the covering hood having at least one recess shaped to receive a covering panel; and
a plurality of corresponding covering panels, each correspondingly shaped to fit into said at least one recess, where said plurality of covering panels have different design characteristics.

8. The garage door drive system in accordance with claim 7, wherein said different design characteristic includes different colors.

9. The garage door drive system in accordance with claim 8, wherein the recess includes an operating field with operating buttons; and each of said plurality of covering panels includes an opening at a corresponding point in the panel so that said buttons are accessible to an operator when coupled to said covering hood.

10. The garage door drive system in accordance with claim 9, wherein the covering hood and/or the panels comprise plastic.

11. The garage door drive system in accordance with claim 9, wherein the panels are configured to be releasably connected to the covering hood.

12. The garage door drive system in accordance with claim 9, wherein said different design characteristic includes different shapes.

13. The garage door drive system in accordance with claim 9, wherein said recess is shaped as a large-area recess substantially forming a side of said garage door drive.

14. A garage door drive system, comprising:
a drive unit;
a covering hood covering the drive unit, the covering hood having at least one recess shaped to receive a covering panel, said recess having figurative symbols and/or alphanumeric signs including manufacturer's data and a type designation of the garage door drive; said recess further having an operating field with operating buttons; and
a plurality of corresponding covering panels, each correspondingly shaped to fit into said at least one recess, where said plurality of covering panels have different design characteristics, said panels further having an opening at a point on the panel aligned with said operating field so that the operating field is accessible from outside through the panel.

15. The garage door drive system in accordance with claim 14, wherein said different design characteristic includes different colors.

16. The garage door drive system in accordance with claim 14, wherein the covering hood comprises plastic.

17. The garage door drive system in accordance with claim 14, wherein the panels comprise plastic.
